(19) United States
(12) Patent Application Publication
(10) Pub. No.: US 2009/0089989 A1
(43) Pub. Date: Apr. 9, 2009

(54) METHOD OF FORMING GAS DIFFUSION LAYER FOR FUEL CELL

(75) Inventors: Keiji Hashimoto, Aichi-ken (JP); Kazuhiko Kato, Niigata-ken (JP)

Correspondence Address: ROSSI, KIMMS & McDOWELL LLP., 20609 Gordon Park Square, Suite 150, Ashburn, VA, 20147, US

(73) Assignees: TOYOTA SHATAI KABUSHIKI KAISHA, Kariya-shi, Aichi (JP); TAMAGAWA HIGH TECH CO., LTD., Agano-shi, Niigata (JP)

(21) Appl. No.: 11/911,188

(22) PCT Filed: Feb. 7, 2007
(86) PCT No.: PCT/JP2007/052545

§ 371 Date: Oct. 10, 2007

(30) Foreign Application Priority Data
Feb. 10, 2006 (JP) 2006-33686

(51) Int. Cl. H01M 8/02

(52) U.S. Cl. 29/2

(57) ABSTRACT

A collector 12 which serves as a gas diffusion layer for a fuel cell; i.e., a metal lath MR, is formed by a method consisting of a first step and a second step. In the first step, while an upper blade UH is positioned at a first machining position along the width direction of a stainless steel sheet S, generally hexagonal through holes are formed in the stainless steel sheet S at two positions which are biased from each other by a machining pitch. In the second step, while the upper blade UH is positioned at a second machining position along the width direction of the stainless steel sheet S, generally hexagonal through holes are formed in the stainless steel sheet S at two positions which are biased from each other by the machining pitch. The first step and the second step are alternated repeatedly, thereby forming the metal lath MR having a uniform shape and a predetermined thickness.

### TECHNICAL FIELD

The present invention relates to a method of forming a gas diffusion layer of metal for use in a fuel cell, particularly, a polymer electrolyte fuel cell.

### BACKGROUND ART

A conventionally known fuel cell is disclosed in, for example, Patent Document 1. In this conventional fuel cell, a separator composed of a thin, flat substrate and a meshy conductor is disposed between adjacent single cells. The meshy conductor is formed from a lance-cut metal (metal lath) or expanded metal in which diamond-shaped slits are formed. The meshy conductor has a generally rectangular cross-sectional shape. Thus, the meshy conductor provides flow paths for supplying air or fuel gas to an electrode diffusion layer and can lead current to the exterior of the fuel cell.

In the field of development of fuel cells, research efforts have been actively carried out on not only improvement of efficiency in generating electricity but also reduction in the size of a fuel cell. In the above-mentioned conventional fuel cell, a generally rectangular cross-sectional shape is imparted to the conductor, thereby securing necessary and sufficient flow paths for air or fuel gas and thus enabling efficient supply of air or fuel gas in a diffused fashion to the electrode diffusion layer. The employment of a metal lath or expanded metal enables uniform contact of the conductor with the electrode diffusion layer at fine contact pitches over the entire surface of the layer. Thus, for example, as compared with a metal sheet in which grooves each having a generally rectangular cross section are formed and in which no through holes are formed, generated electricity can be more efficiently led out to the exterior of the fuel cell. Therefore, the employment of a metal lath or expanded metal can sufficiently improve the efficiency in generation of electricity by the fuel cell.

However, imparting a generally rectangular cross-sectional shape to the conductor hinders reduction in size of the fuel cell. Therefore, there remains room to study reduction in size of the fuel cell. In this connection, in the case of employing a material having a large number of through holes, such as a metal lath or an expanded metal, to form a conductor, use of these through holes themselves as passages for air or fuel gas; i.e., use of the generally flat metal lath or expanded metal as a conductor is conceived. In this case, the employment of, for example, a ribbed, expanded metal disclosed in Patent Document 2 or a metal lath in a stepped form, which is a preliminary product to be formed into this expanded metal, is conceivable.

Patent Document 1: Japanese Patent Application Laid-Open (kokal) No. 2005-209470
Patent Document 2: Japanese Patent Application Laid-Open (kokal) No. 2001-47153

However, since the above-mentioned conventional metal lath and expanded metal are very thin and involve high resistance to flow of air or fuel gas; i.e., high pressure loss, using the metal lath or expanded metal as a conductor may result in a failure to sufficiently supply air and fuel gas to the respective electrode layers of the fuel cell. In order to cope with this problem by means of increasing the thickness of the above-mentioned conventional metal lath or expanded metal, increasing a machining pitch for staggered shearing is conceivable. However, since a metal sheet as material has low resistance to deformation, the shape of a cutting die is unlikely to be transferred to the metal sheet. Thus, difficulty is involved in manufacturing a metal lath or expanded metal having an appropriate thickness. When the shape of a cutting die is not properly transferred to the metal sheet, formed through-holes become nonuniform in shape. As a result, pressure loss may possibly increase further.

### DISCLOSURE OF THE INVENTION

The present invention has been achieved for solving the above problems, and an object of the invention is to provide a method of forming a gas diffusion layer of metal for a fuel cell in which pressure loss associated with supply of gas is lowered so as to efficiently and smoothly supply gas.

To achieve the above object, the present invention provides a method of forming a gas diffusion layer for a fuel cell which is made of metal and in which a large number of through holes are arranged in a staggered fashion for supplying fuel gas or oxidizer gas in a diffused condition to a corresponding electrode layer of an electrode structure of the fuel cell. The method uses a forming apparatus having a stationary die on which a metal sheet is placed, and a cutting die which is biased from the stationary die in a direction of feed of the metal sheet and which advances and retreats in a thickness direction of the metal sheet and moves in a width direction of the metal sheet so as to cut the metal sheet for forming through holes each having a desired shape and arranged in a staggered fashion. The method comprises a first step of executing, a plurality of times, a machining cycle consisting of feeding the metal sheet by a predetermined machining pitch and advancing and retreating the cutting die in the thickness direction of the metal sheet so as to form the through holes each having the desired shape, and a second step of, after the first step, moving the cutting die in the width direction of the metal sheet by a predetermined distance and executing the machining cycle the plurality of times and subsequently moving the cutting die by the predetermined distance in a direction opposite that of the moving of the cutting die along the width direction of the metal sheet. In the method, the first step and the second step are repeated.

According to the method of the present invention, the first step and the second step each execute, a plurality of times, the machining cycle consisting of feeding the metal sheet by the predetermined machining pitch and cutting through holes by means of the cutting die, so as to accurately form the through holes each having the desired shape. The first step and the second step are repeated so as to form the gas diffusion layer for a fuel cell. The thus-formed gas diffusion layer for a fuel cell has through holes which are uniform in shape, and a portion of the gas diffusion layer to which the shape of the cutting die is transferred; i.e., a stepped portion of the gas diffusion layer, can be increased in thickness and thus can have a thickness suitable for flow of air or a fuel gas.

Accordingly, by employing this gas diffusion layer in a fuel cell, pressure loss associated with flow of air or a fuel gas therethrough can be lowered, and thus an electrode layer can be supplied with sufficient air or fuel gas for an electrode reaction. Also, since a large number of through holes can be uniformly formed, generated electricity can be efficiently output to the exterior of the electrode. Thus, the fuel cell can exhibit sufficiently high efficiency in generation of electricity. Also, since there is no need to form, for example, grooves each having a generally rectangular cross section in the gas diffusion layer for a fuel cell, the size of the fuel cell can be reduced. Therefore, the fuel cell can attain compatibility between good efficiency in generation of electricity and reduction in size.

This method of forming a gas diffusion layer for a fuel cell can further comprise a third step of, after the second step and before the first step, feeding the metal sheet by the predetermined machining pitch and advancing and retreating the cutting die once in the thickness direction of the metal sheet so as to form the through holes each having the desired shape and subsequently moving the cutting die by the predetermined distance in a direction opposite that of the moving of the cutting die along the width direction of the metal sheet which is performed in the second step after the execution of the plurality of machining cycles. In the method, the first step, the second step, and the third step are repeated. According to the method, portions of the gas diffusion layer formed by execution of the third step are smaller in thickness than portions of the gas diffusion layer formed by execution of the first and second steps. These thinner portions of the gas diffusion layer facilitate flow of air or a fuel gas, so that pressure loss can further be lowered.

### BRIEF DESCRIPTION OF THE DRAWINGS

FIG. 1 is a schematic view partially showing a fuel cell stack which uses collectors according to a first embodiment of the present invention.

FIG. 2 is a schematic, perspective view showing a separator body of each of separators shown in FIG. 1.

FIGS. 3A and 3B are views for explaining a metal lath used to form the collector.

FIG. 4A is a schematic view showing a metal-lath-machining apparatus for forming the metal lath of FIG. 3.

FIG. 4B is a view for explaining the shape of a blade die of FIG. 4A.

FIGS. 5A to 5D are schematic views for explaining a first step for forming the metal lath of FIG. 3.

FIGS. 6A to 6D are schematic views for explaining a second step for forming the metal lath of FIG. 3.

FIG. 7 is a schematic, exploded perspective view for explaining a state of assembly of a frame and an MEA shown in FIG. 1.

FIG. 8 is a view for explaining a metal lath used to form a collector according to a second embodiment of the present invention.

FIG. 9 is a view for explaining a metal lath according to a modified embodiment of the present invention.

FIG. 10 is a view for explaining a metal lath according to another modified embodiment of the present invention.

FIG. 11 is a view for explaining a metal lath according to a further modified embodiment of the present invention.

### BEST MODE FOR CARRYING OUT THE INVENTION

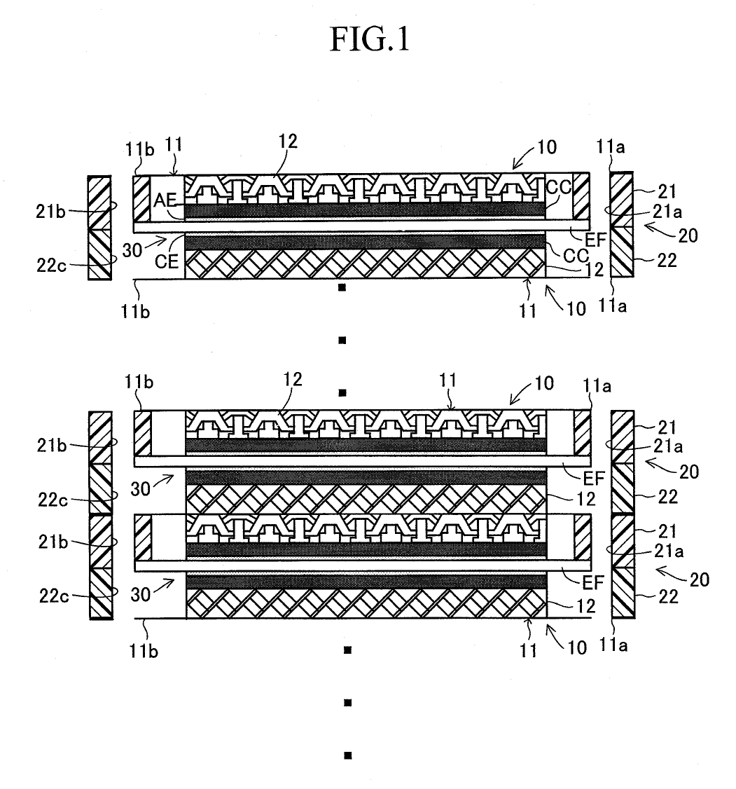

Embodiments of the present invention will next be described in detail with reference to the drawings. FIG. 1 relates to a first embodiment of the present invention, and schematically shows a portion of a polymer electrolyte fuel cell stack which uses separators 10 for a fuel cell (hereinafter, referred to merely as the separators 10). This fuel cell stack is a stack of cells. A single cell includes two separators 10, a frame 20, and an MEA (Membrane-Electrode Assembly) 30. The frame 20 and the MEA 30 are sandwiched between the separators 10. When fuel gas such as hydrogen gas, and oxidizer gas such as air are introduced to the cells from the exterior of the fuel cell stack, electrode reactions occur in the MEAs 30, thereby generating electricity. Hereinafter, fuel gas and oxidizer gas may be collectively referred to as gas. Oxidizer gas may contain water mist for removing heat generated in association with electrode reactions in the MEAs 30 and for maintaining appropriate water content in the MEAs 30.

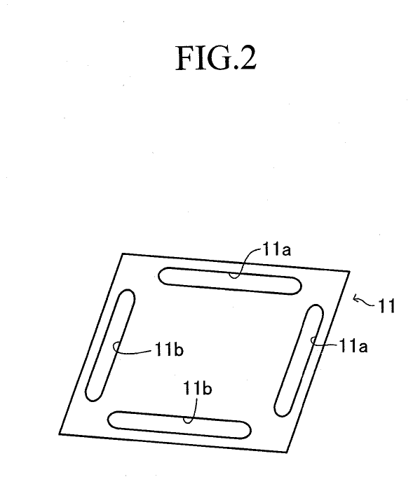

The separator 10 includes a separator body 11 formed into a generally square, flat-sheet-like shape and adapted to prevent a mixed flow of gases introduced into the fuel cell stack, and a collector 12 for uniformly diffusing externally supplied fuel gas or oxidizer gas to the MEA 30 and for collecting electricity generated through electrode reactions. As shown in FIG. 2, the separator body 11 is formed from a metal sheet (e.g., a stainless steel sheet having a thickness of about 0.1 mm). Another applicable metal sheet is, for example, a steel sheet which has undergone anticorrosive treatment such as gold plating.

Two gas inlets 11a and two gas outlets 11b are formed in a peripheral region of the separator body 11 in such a manner that the gas inlets 11a face the corresponding gas outlets 11b. A pair consisting of the gas inlet 11a and the gas outlet 11b is oriented generally orthogonal to the other pair consisting of the gas inlet 11a and the gas outlet 11b. Each of the gas inlets 11a assumes the form of an elongated through hole and allows fuel gas or oxidizer gas supplied from the exterior of the fuel cell stack to be introduced therethrough into the corresponding cell and to flow therethrough so as to be supplied to other stacked cells. Each of the gas outlets 11b also assumes the form of an elongated through hole and allows discharge therethrough, to the exterior of the fuel cell stack, of gas which has been introduced into the corresponding cell but remains unreacted in the MEA 30, as well as flow therethrough of unreacted gas from other stacked cells for discharge to the exterior of the fuel cell stack.

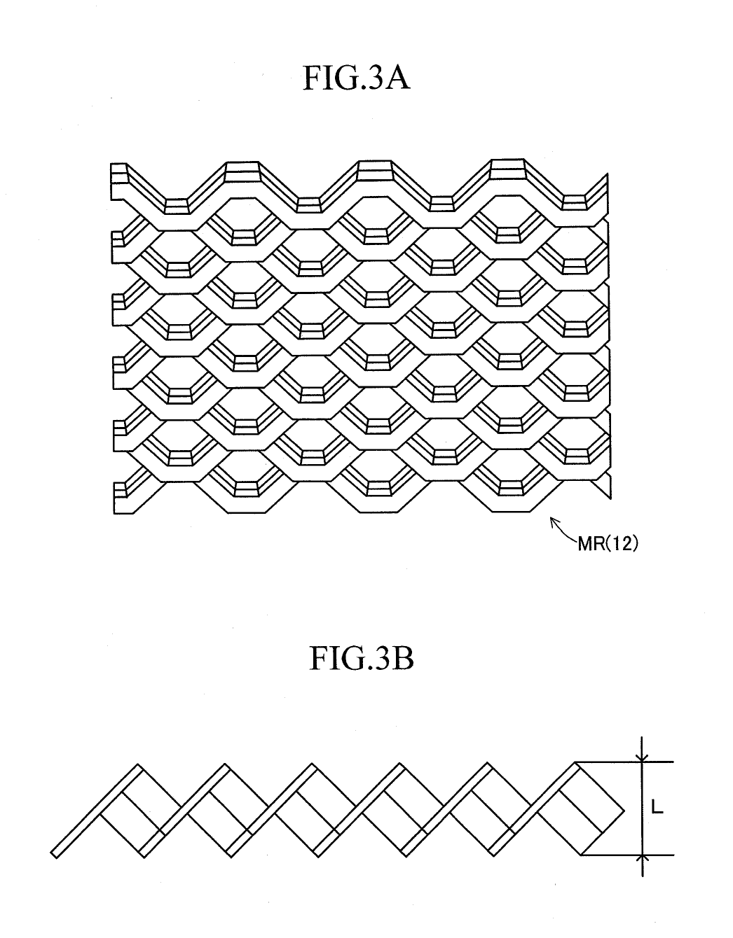

As shown in FIG. 3A, the collector 12 is formed from a metal sheet having a large number of generally hexagonal small-diameter through holes formed in a meshy arrangement (hereinafter, this metal sheet is called a metal lath MR). This metal lath MR is formed from a metal sheet (e.g., a stainless steel sheet) having a thickness of about 0.1 mm, and a large number of through holes formed therein each have a diameter of about 0.1 mm to 1 mm. As shown in FIG. 3B, which is a side view of FIG. 3A, the metal lath MR is such that portions which form the through holes in a meshy arrangement are sequentially linked in an overlapping fashion, thus having a step-like cross section. The metal lath MR is manufactured by the following metal-lath-forming process, which is a method of forming a gas diffusion layer for use in a fuel cell.

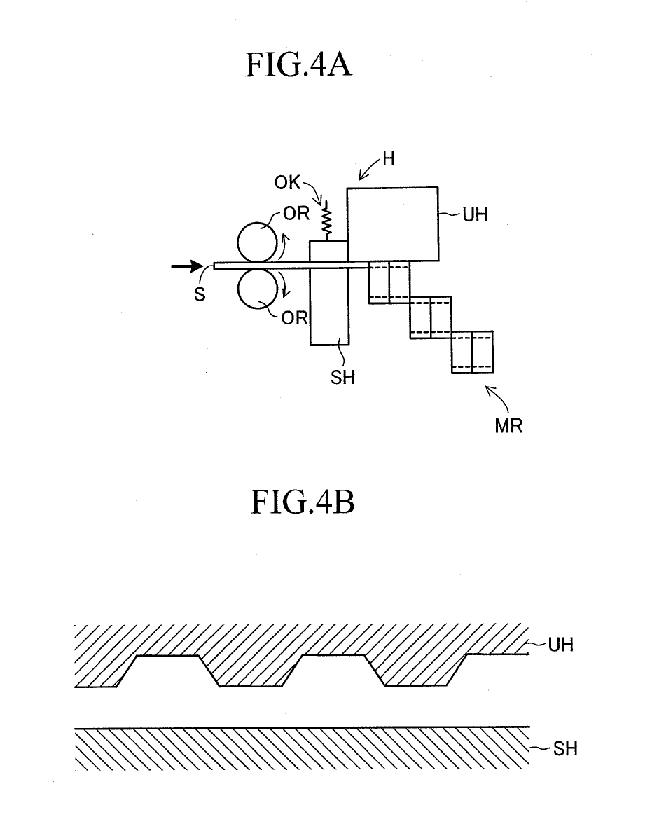

The metal-lath-forming process uses a metal-lath-machining apparatus R schematically shown in FIG. 4A and forms a large number of through holes in a stainless steel sheet S in a meshy and step-like arrangement. The metal-lath-machining apparatus R includes a feed roller OR for feeding the stainless steel sheet S; a holder mechanism OK for appropriately fixing the stainless steel sheet S during machining; and a blade die H for sequentially shearing the stainless steel sheet S so as to form through holes in a meshy staggered arrangement. The stainless steel sheet S may assume the form of a precut sheet having a predetermined length or the form of a coil.

The blade die H consists of a lower blade SH which serves as a stationary die and is fixed on an unillustrated base and on which the stainless steel sheet S is placed, and an upper blade UH which serves as a cutting die and can move in a thickness direction of the stainless steel sheet S (in a vertical direction in FIG. 4A) and in a width direction of the stainless steel sheet S (in a direction perpendicular to paper on which FIG. 4A appears). As shown in FIG. 4B, the lower blade SH has a flat top surface so as to appropriately fix the stainless steel sheet S in cooperation with the holder mechanism OK. The upper blade UH has a plurality of generally trapezoidal cutting edges for forming cuts in the stainless steel sheet S in a staggered arrangement by shearing and for forming generally hexagonal through holes in the stainless steel sheet S by drawing.

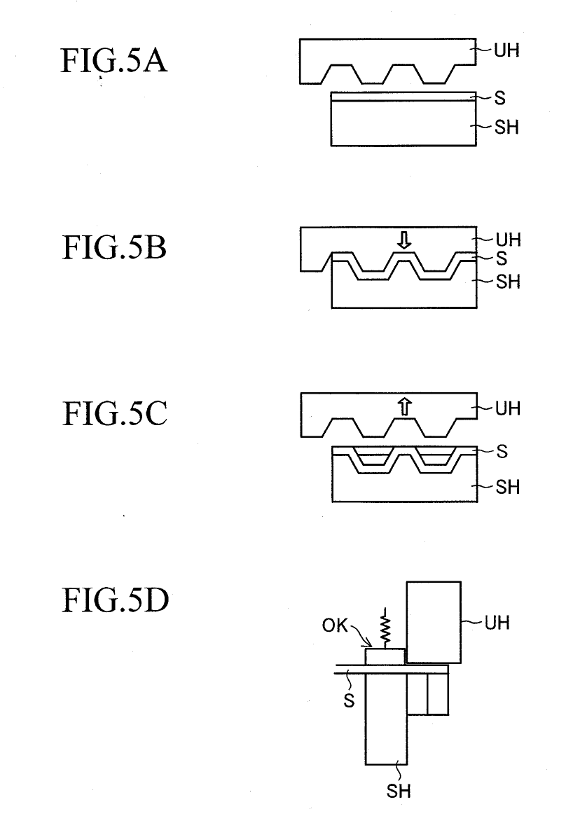

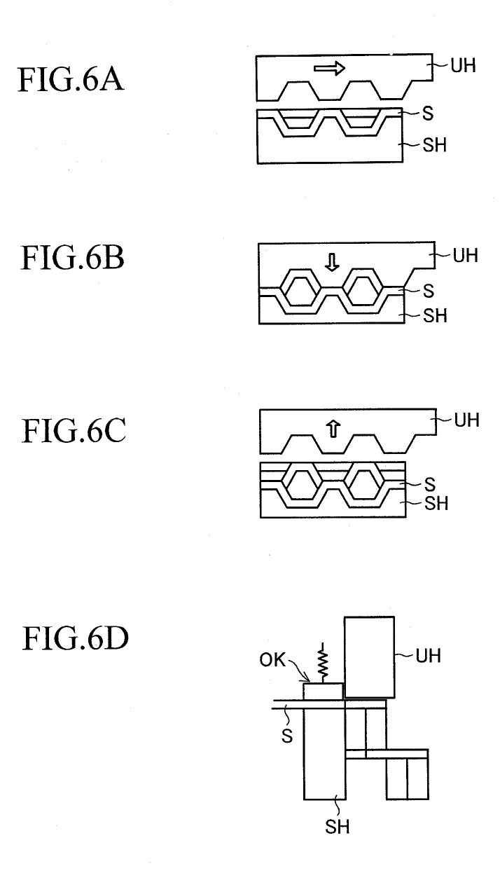

In the present embodiment, the metal-lath-forming process which uses the thus-configured metal-lath-machining apparatus R consists of two steps; i.e., a first step and a second step. In the first step, the upper blade UH is positioned at a predetermined position along a width direction of the stainless steel sheet S (hereinafter, this predetermined position is called the first machining position) and forms generally hexagonal through holes in the stainless steel sheet S. In the second step, the upper blade UH is positioned at a position (hereinafter, this position is called the second machining position) located a predetermined distance (e.g., half the pitch between the trapezoidal cutting edges) away from the first machining position along the width direction of the stainless steel sheet S and forms generally hexagonal through holes in the stainless steel sheet S. The metal-lath-forming process will be described below with reference to FIGS. 5 and 6.

First, as shown in FIG. 5A, in the first step, while the upper blade UH is positioned at the first machining position, the feed roller OR feeds the stainless steel sheet S to the blade die H by a predetermined machining length (machining pitch). Then, as shown in FIG. 5B, the upper blade UH lowers toward the lower blade SH; i.e., lowers along the thickness direction of the stainless steel sheet S, thereby partially shearing the stainless steel sheet S and thus forming cuts in a staggered arrangement through cooperation between the generally trapezoidal cutting edges thereof and the lower blade SH. Subsequently, the upper blade UH lowers further to the bottom point of its stroke, thereby bending and drawing downward portions of the stainless steel sheet S which are in contact with the cutting edges of the upper blade UH. Subsequently, as shown in FIG. 5C, the upper blade UH returns to its upper original position of its stroke; i.e., the first machining position. Thus, the shape of the cutting edges of the upper blade UH is transferred to the machined portions of the stainless steel sheet S.

Subsequently, the feed roller OR feeds the stainless steel sheet S again by the machining pitch to the upper blade UH which has returned to the first machining position, and the upper blade UH operates as shown in FIGS. 5B and 5C. Through repeated execution of the machining cycle represented in FIGS. 5A to 5C (in the present embodiment, execution of two machining cycles), the upper blade UH transfers, at the first machining position, the shape of its cutting edges to the stainless steel sheet S at those positions which are biased from one another by the machining pitch. That is, as a result of the machining cycle being executed two times on the stainless steel sheet S, the shape of the cutting edges of the upper blade UH is transferred two times onto the stainless steel sheet S, thereby forming a step-like shape of the metal lath MR as shown in FIG. 5D. The number of machining cycles to be executed is not limited to two, but the machining cycle may be executed three times or more.

Subsequently to the above execution of the first step, the second step is executed. Specifically, in the second step, first, as shown in FIG. 6A, the upper blade UH moves to the second machining position. While the upper blade UH is positioned at the second machining position, the feed roller OR feeds the stainless steel sheet S to the blade die H by the machining pitch. Then, as shown in FIG. 6B, the upper blade UH lowers toward the lower blade SH; i.e., lowers along the thickness direction of the stainless steel sheet S, thereby partially shearing the stainless steel sheet S and thus forming cuts in a staggered arrangement through cooperation between the generally trapezoidal cutting edges thereof and the lower blade SH. Subsequently, the upper blade UH lowers further to the bottom point of its stroke, thereby bending and drawing downward portions of the stainless steel sheet S which are in contact with the cutting edges of the upper blade UH. Subsequently, as shown in FIG. 6C, the upper blade UH returns to its upper original position of its stroke; i.e., the second machining position. Thus, the shape of the cutting edges of the upper blade UH is transferred to the machined portions of the stainless steel sheet S.

Subsequently, the feed roller OR feeds the stainless steel sheet S again by the machining pitch to the upper blade UH which has returned to the second machining position, and the upper blade UH operates as shown in FIGS. 6B and 6C. Through repeated execution of the machining cycle represented in FIGS. 6A to 6C (in the present embodiment, execution of two machining cycles), the upper blade UH transfers, at the second machining position, the shape of its cutting edges to the stainless steel sheet S at those positions which are biased from one another by the machining pitch. That is, as a result of the machining cycle being executed two times on the stainless steel sheet S, the shape of the cutting edges of the upper blade UH is transferred two times onto the stainless steel sheet S, thereby forming a step-like shape of the metal lath MR as shown in FIG. 6D. The number of machining cycles to be executed is not limited to two, but the machining cycle may be executed three times or more.

When the machining cycle is executed two times in the second step, the upper blade UH moves from the second machining position shown in FIG. 6A to the first machining position shown in FIG. 5A. The first step is again executed. When the machining cycle is executed two times in the first step, the upper blade UH moves from the first machining position shown in FIG. 5A to the second machining position shown in FIG. 6A. The second step is again executed. In this manner, through repeated execution of the first step and the second step, the metal lath MR shown in FIG. 3A is formed. Executing the machining cycle two times in each of the first and second steps increases the thickness of the stepped portions of the metal lath MR as shown in FIG. 3B; i.e., a thickness L of the metal lath MR.

The metal lath MR is cut so as to have predetermined product dimensions; specifically, a square shape having the same size as that of an anode electrode layer AE or a cathode electrode layer CE of the MEA 30, which will be described later, thereby being formed into the collector 12.

The collector 12 is fixedly attached to the separator body 11, thereby forming the separator 10. This process of fixedly attaching the collector 12 is briefly described below. The collector 12 is placed in a generally central region of the separator body 11. The separator 11 and the collector 12 are metallically joined together at contact portions therebetween by, for example, brazing.

Specifically, first, a paste-like brazing material of, for example, copper or nickel is applied to the collector 12. The collector 12 coated with the brazing material is provisionally fixed to the separator body 11 at a predetermined position. Next, in a reducing gas atmosphere, this provisional assembly of the separator body 11 and the collector 12 is heated at a predetermined temperature for a predetermined period of time and is then cooled. This metallically joins the separator body 11 and the collector 12 together.

A method of metallically joining the separator body 11 and the collector 12 together is not limited to brazing. For example, welding or diffusion bonding may be employed for metallically joining the separator body 11 and the collector 12 together.

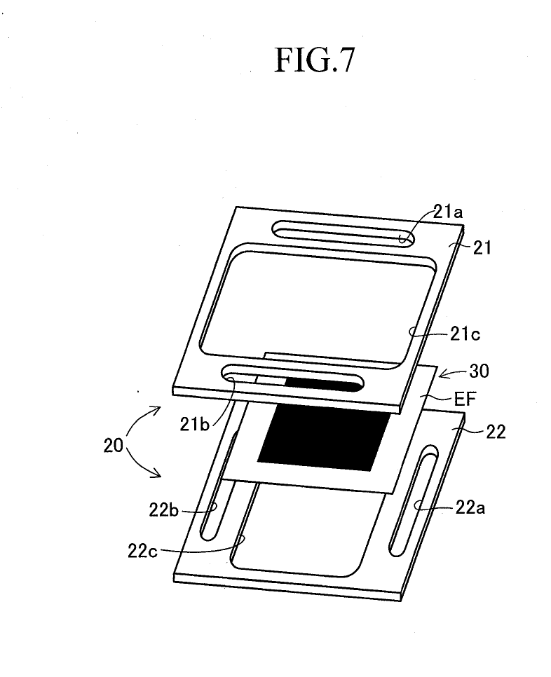

As shown in FIG. 7, a frame 20 consists of two resin sheet bodies 21 and 22 of the same structure. One side of each of the resin sheet bodies 21 and 22 is fixedly attached to the corresponding separator 10 (more specifically, the separator body 11). The resin sheet bodies 21 and 22 have outside dimensions generally identical with those of the separator body 11 and a thickness slightly smaller than the forming height of the collector 12; i.e., the thickness L of the metal lath MR. The resin sheet bodies 21 and 22 are disposed in layers in such a manner as to differ in horizontally angular orientation by about 90 degrees. Various resin materials can be used to form the resin sheet bodies 21 and 22. Particularly, glass epoxy resin is preferred.

Through holes 21a and 21b which correspond to and are shaped generally similarly to the gas inlet 11a and the gas outlet 11b, respectively, are formed in a peripheral region of the resin sheet body 21, and through holes 22a and 22b which correspond to and are shaped generally similarly to the gas inlet 11a and the gas outlet 11b, respectively, are formed in a peripheral region of the resin sheet body 22. In a state where a single cell is formed, the through holes 21a, 21b, 22a, and 22b positionally coincide with the corresponding gas inlets 11a and gas outlets 11b of the separator bodies 11. Accommodation holes 21c and 22c for accommodating the respective collectors 12 joined to the separator bodies 11 are formed in generally central regions of the resin sheet bodies 21 and 22, respectively. The accommodation hole 21c of the resin sheet body 21 communicates with a pair consisting of the gas inlet 11a and the gas outlet 11b of each of the two separator bodies 11 and with the through holes 22a and 22b of the resin sheet body 22, whereas the accommodation hole 22c of the resin sheet body 22 communicates with the other pair consisting of the gas inlet 11a and the gas outlet 11b of each of the two separator bodies 11 and with the through holes 21a and 21b of the resin sheet body 21.

As a result of formation of the accommodation hole 21c (22c), the lower surface (upper surface) of the attached separator body 11, the inner peripheral surface of the accommodation hole 21c (22c), and the upper surface (lower surface) of the MEA 30 define a space (hereinafter, called a gas flow space). For example, fuel gas can be introduced into the gas flow space associated with the accommodation hole 21c through one gas inlet 11a, whereas oxidizer gas can be introduced into the gas flow space associated with the accommodation hole 22c through the other gas inlet 11a and through the through hole 21a. Also, unreacted gas which has passed one gas flow space can be discharged to the exterior of the fuel cell stack through one gas outlet 11b, whereas unreacted gas which has passed another gas flow space can be discharged to the exterior of the fuel cell stack through the through hole 21b and through the other gas outlet 11b. In formation of the through holes 21a and 21b and the accommodation hole 21c in the resin sheet body 21, and the through holes 22a and 22b and the accommodation hole 22c in the resin sheet body 22, the resin sheet bodies 21 and 22 whose thickness is controlled are subjected to, for example, blanking. Alternatively, the resin sheet body 21 (22) may be formed by, for example, injection molding such that the through holes 21a and 21b (22a and 22b) and the accommodation hole 21c (22c) are formed therein.

As shown in FIGS. 1 and 7, the MEA 30, which serves as an electrode structure, is configured such that predetermined catalyst layers are formed on respective sides of an electrolyte membrane EF; more specifically, an anode electrode layer AE is formed on the side toward the gas flow space into which fuel gas is introduced, and a cathode electrode layer CE is formed on the side toward the gas flow space into which oxidizer gas is introduced. Since actions (electrode reactions) of the electrolyte membrane EF, the anode electrode layer AE, and the cathode electrode layer CE are not directly related to the present invention, detailed description thereof is omitted. The size of the electrolyte membrane EF is determined so as to be greater than a generally square opening which is formed when the resin sheet bodies 21 and 22 of the frame 20 are superposed on each other, and so as not to cover the through holes 21a and 21b and the through holes 22a and 22b when the electrolyte membrane EF is sandwiched between the resin sheet bodies 21 and 22. Such formation of the electrolyte membrane EF prevents leakage of gas introduced into one gas flow space into the other gas flow space. The anode electrode layer AE and the cathode electrode layer CE are slightly smaller in size than the generally square opening which is formed when the resin sheet bodies 21 and 22 of the frame 20 are superposed on each other.

An exposed surface of each of the anode electrode layer AE and the cathode electrode layer CE of the MEA 30 is covered with a carbon cloth CC formed from electrically conductive fiber. The carbon cloth CC provides large contact area between the collector 12 and the anode electrode layer AE or the cathode electrode layer CE and absorbs dimensional errors of components when a single cell is formed. The MEA 30 may be formed without employment of the carbon cloths CC.

A single cell is formed by arranging in layers the frame 20 and the MEA 30 between the two separators 10, each of which is formed by metallically joining the separator body 11 and the collector 12 together. Specifically, the MEA 30 is disposed between the resin sheet bodies 21 and 22 which are disposed in such a manner as to differ in horizontally angular orientation by about 90 degrees. The thus-arranged elements are joined together, for example, through application of adhesive such that the electrolyte membrane EF of the MEA 30 is sandwiched between the resin sheet bodies 21 and 22. The two separators 10 are fixedly attached to the resultant assembly of the frame 20 and the MEA 30, for example, through application of adhesive. At this time, the two collectors 12 are accommodated in the respective accommodation holes 21c and 22c of the frame 20 in such a manner that the forming direction of each of the two collectors 12 (more specifically, the metal laths MR) coincides with the flow direction of gas introduced into the corresponding gas introduction space. A large number of thus-formed cells are stacked into the fuel cell stack.

In the thus-configured fuel cell stack, as shown in FIG. 1, among the stacked cells, the gas inlets 11a communicate with one another through the through holes 21a or 22a of the frames 20, and the gas outlets 11b communicate with one another through the through holes 21b or 22b of the frames 20. Thus, hereinafter, a communication passageway formed by the gas inlets 11a to the respective cells and the through holes 21a and 22a of the frames 20 is called a gas supply inner-manifold, and a communication passageway formed by the gas outlets 11b from the respective cells and the through holes 21b and 22b of the frames 20 is called a gas discharge inner-manifold. The gas supply inner-manifold and the gas discharge inner-manifold are collectively called the inner manifold.

When fuel gas or oxidizer gas is externally supplied under pressure through the gas supply inner-manifold, the supplied fuel gas or oxidizer gas is introduced into each of the gas flow spaces. By virtue of the collector 12, the thus-introduced fuel gas or oxidizer gas appropriately diffuses and flows throughout the gas flow space with uniform gas concentration gradient.

The collector 12 is formed from the metal lath MR in which a large number of small through holes are formed in a meshy arrangement. The metal lath MR is formed in such a manner as to have large thickness L. By virtue of large thickness L, in such a state that the collector 12 is accommodated in the gas flow space, gas can diffuse throughout the gas flow space while passing through a large number of small through holes. Thus, the gas concentration gradient in the gas flow space becomes uniform, and the entire surface of each of the anode electrode layer AE and the cathode electrode layer CE becomes an electrode reaction region. As a result, since an effective electrode reaction region increases, electrode reactions effectively occur between the anode electrode layer AE or the cathode electrode layer CE and supplied fuel gas or oxidizer gas, thereby greatly improving electrode reaction efficiency. Since supplied gas can be effectively utilized, unreacted gas reduces. Therefore, the fuel cell can efficiently generate electricity.

By virtue of impartment of large thickness L to the collector 12; i.e., the metal lath MR, excellent gas diffusibility is achieved as mentioned above, and resistance of gas; i.e., pressure loss, associated with flow through the gas flow space can be lowered. Furthermore, gas introduced into the gas flow space can be lowered in resistance associated with passage through a large number of uniformly formed small through holes. Thus, gas can smoothly flow through the gas flow space, thereby accelerating reaction between gas and each of the anode electrode layer AE and the cathode electrode layer CE. Therefore, the fuel cell can exhibit improved efficiency in generation of electricity.

Improvement in efficiency of electrode reactions leads to efficient generation of electricity in the MEA 30. Generated electricity is led out to the exterior of the fuel cell via the collectors 12 and the separator bodies 11. In this connection, since a large number of small through holes are formed in the collector 12, the surface area per unit volume; i.e., the contact area between the collector 12 and the MEA 30, becomes large. Through establishment of large contact area between the collector 12 and the MEA 30, resistance associated with collection of electricity generated in the MEA 30 (electricity collection resistance) can be lowered greatly, so that generated electricity can be collected efficiently; i.e., at high electricity collection efficiency.

As will be understood from the above description, according to the first embodiment, the flat-sheet-like collectors 12 each being formed from the metal lath MR are employed in the fuel cell, whereby pressure loss associated with flow of gas can be lowered, and gas required for electrode reactions can be sufficiently supplied to the MEAs 30. Since a large number of through holes can be uniformly formed in the collectors 12, generated electricity can be efficiently output to the exterior of the fuel cell. These features enable the fuel cell to provide sufficiently high efficiency in generating electricity. Since there is no need to form grooves each having a generally rectangular cross section in the collectors 12, the size of the fuel cell can be reduced. Therefore, the fuel cell can attain compatibility between good efficiency in generating electricity and reduction in size.

According to the above-described first embodiment, the metal lath MR used to form the collector 12 is manufactured by the metal-lath-forming process in which the first step and the second step are repeatedly executed. According to a second embodiment of the present invention, the metal lath MR is manufactured by a metal-lath-forming process consisting of the above-described first and second steps and a third step. The second embodiment will be described below in detail. In the description of the second embodiment, like features of the first and second embodiments are denoted by like reference symbols, and repeated description thereof is omitted.

As in the case of the above-described first embodiment, the metal-lath-forming process of the second embodiment uses the metal-lath-machining apparatus R and forms a large number of through holes in a meshy arrangement in the stainless steel sheet S. Specifically, after execution of the first step, in which the above-mentioned machining cycle is repeated two times with the upper blade UH positioned at the first machining position, there is executed the second step, in which the upper blade UH is moved from the first machining position to the second machining position, and the machining cycle is repeated two times with the upper blade UH positioned at the second machining position. The metal-lath-forming process of the second embodiment executes the third step after execution of the second step. Specifically, the upper blade UH is moved from the machining position of the second step in a direction opposite that of the preceding movement thereof along the width direction of the stainless steel sheet S; i.e., in this case, from the second machining position to the first machining position. At the first machining position, the machining cycle is executed once.

That is, in the third step of this case, while the upper blade UH is positioned at the first machining position, the feed roller OR feeds the stainless steel sheet S to the blade die H by the predetermined machining length (machining pitch). Then, the upper blade UH lowers toward the lower blade SH; i.e., lowers along the thickness direction of the stainless steel sheet S, thereby partially shearing the stainless steel sheet S and thus forming cuts in a staggered arrangement through cooperation between the generally trapezoidal cutting edges thereof and the lower blade SH. Subsequently, the upper blade UH lowers further to the bottom point of its stroke, thereby bending and drawing downward portions of the stainless steel sheet S which are in contact with the cutting edges of the upper blade UH. Subsequently, the upper blade UH returns to its upper original position of its stroke; i.e., the first machining position. Thus, the shape of the cutting edges of the upper blade UH is transferred to the machined portions of the stainless steel sheet S.

After the upper blade UH is returned to the original position (in this case, the first machining position), the upper blade UH is moved in a direction opposite that of the preceding movement thereof along the width direction of the stainless steel sheet S; i.e., in this case, from the first machining position to the second machining position, whereat the execution of the third step is completed. Subsequently, while the upper blade UH is positioned at the second machining position, the first step is executed. That is, the first step to be executed after the third step is such that, while the upper blade UH is positioned at the second machining position, the machining cycle is executed two times. The second step to be executed after this first step is such that, while the upper blade UH is positioned at the first machining position, the machining cycle is executed two times. In this case, the third step is such that, while the upper blade UH is positioned at the second machining position, the machining cycle is executed once. In this manner, in manufacture of the metal lath MR by the metal-lath-forming process of the second embodiment, the machining position where the upper blade UH starts machining alternates, in each step, between the first machining position and the second machining position.

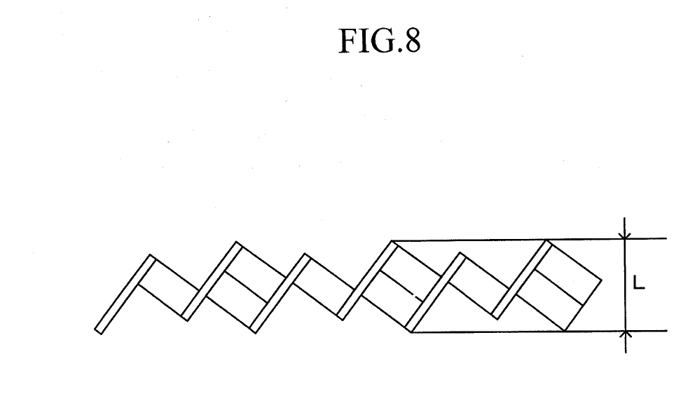

As a result of the metal-lath-forming process including the third step, as shown in FIG. 8, the metal lath MR has the following step-like shape: a portion where the shape of cutting edges is transferred two times (hereinafter, called the two-step portion), and a portion where the shape of cutting edges is transferred once (hereinafter, called the one-step portion) emerge alternately. Thus, the one-step portion becomes smaller in thickness than the two-step portion. In a state where the collector 12 is joined to the separator body 11 as mentioned above in the description of the first embodiment, a clearance is formed therebetween at the one-step portions. Formation of such a clearance between the separator body 11 and the collector 12 further lowers pressure loss associated with flow of gas. Other effects of the second embodiment are similar to those of the first embodiment.

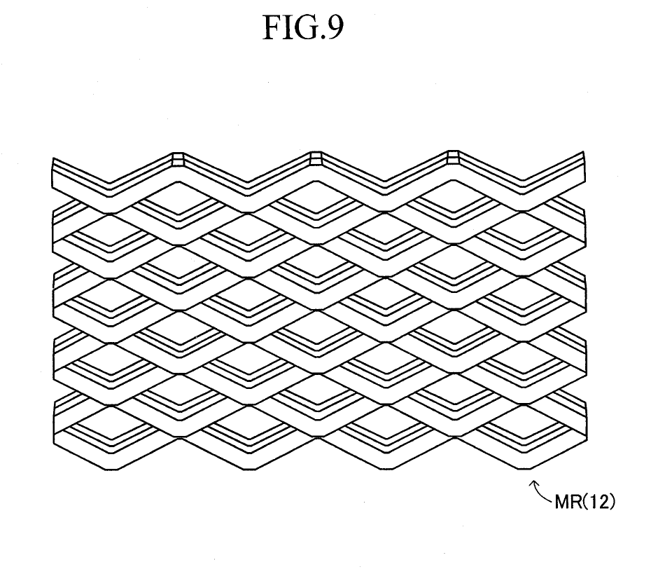

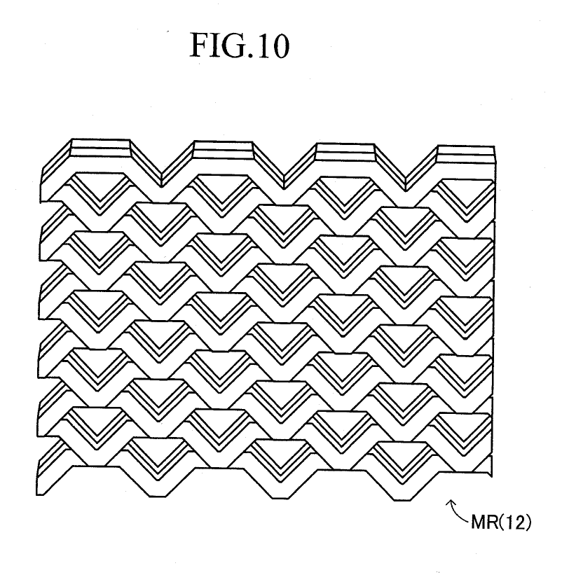

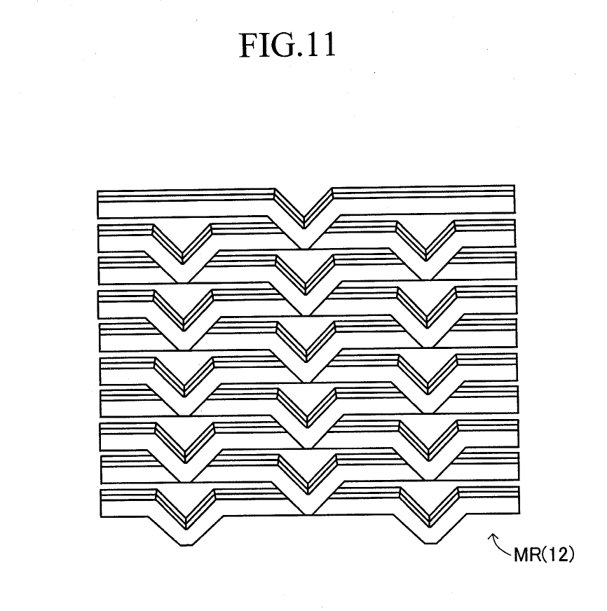

The present invention is not limited to the above-described embodiments. Numerous modifications and variations of the present invention are possible. For example, the first and second embodiments are described while mentioning the metal lath MR in which generally hexagonal through holes are formed. However, through holes formed in the metal lath MR can assume various other shapes as shown in FIGS. 9 to 11. Even in this case, the employment of the metal-lath-forming process of the first or second embodiment can impart an appropriate thickness to the metal lath MR. As a result, the pressure loss of gas introduced into the gas introduction space can be lowered, and generated electricity can be efficiently collected. That is, effects similar to those of the first and second embodiments can be yielded.

According to the first and second embodiments, the collector 12 and the separator body 11 are metallically joined together. However, the present invention can be embodied without the collector 12 and the separator body 11 being metallically joined together.

### INDUSTRIAL APPLICABILITY

The present invention can be applied to a method of forming a gas diffusion layer of metal for use in a fuel cell.

1. A method of forming a gas diffusion layer for a fuel cell which is made of metal and in which a large number of through holes are arranged in a staggered fashion for supplying a fuel gas or an oxidizer gas in a diffused condition to a corresponding electrode layer of an electrode structure of the fuel cell, the method using
a forming apparatus having a stationary die on which a metal sheet is placed, and a cutting die which is biased from the stationary die in a direction of feed of the metal sheet and which advances and retreats in a thickness direction of the metal sheet and moves in a width direction of the metal sheet so as to cut the metal sheet for forming through holes each having a desired shape and arranged in a staggered fashion, and comprising
a first step of executing, a plurality of times, a machining cycle consisting of feeding the metal sheet by a predetermined machining pitch and advancing and retreating the cutting die in the thickness direction of the metal sheet so as to form the through holes each having the desired shape, and
a second step of, after the first step, moving the cutting die in the width direction of the metal sheet by a predetermined distance and executing the machining cycle the plurality of times and subsequently moving the cutting die by the predetermined distance in a direction opposite that of the moving of the cutting die along the width direction of the metal sheet,
wherein the first step and the second step are repeated.

2. A method of forming a gas diffusion layer for a fuel cell according to claim 1, further comprising a third step of, after the second step and before the first step, feeding the metal sheet by the predetermined machining pitch and advancing and retreating the cutting die once in the thickness direction of the metal sheet so as to form the through holes each having the desired shape and subsequently moving the cutting die by the predetermined distance in a direction opposite that of the moving of the cutting die along the width direction of the metal sheet which is performed in the second step after the execution of the plurality of machining cycles,
wherein the first step, the second step, and the third step are repeated.
